(19) United States
(12) Patent Application Publication
(10) Pub. No.: US 2016/0271768 A1
(43) Pub. Date: Sep. 22, 2016

(54) BIT HOLDER AND COMBINATION OF TOOL BIT AND BIT HOLDER

(71) Applicant: CHERVON (HK) LIMITED, Wanchai (HK)

(72) Inventors: Xiaofeng Zhang, Nanjing (CN); Rongzhen Li, Nanjing (CN)

(21) Appl. No.: 15/070,156

(22) Filed: Mar. 15, 2016

(30) Foreign Application Priority Data
Mar. 17, 2015 (CN) 201510117526.2

(51) Int. Cl. B25B 23/00; B25B 23/12

(52) U.S. Cl. CPC B25B 23/0035; B25B 23/12

(57) ABSTRACT

A bit holder includes a body having a shank at its rearward end and a socket formed at its forward end to allow a tool bit to be inserted therein, a sleeve slidably disposed on the body, a collar detachably coupled to the sleeve, and a first magnet member disposed at a forward side of the collar to magnetize a fastener and retain the fastener engaged to the tool bit. The collar defines a through-hole to allow the tool bit to pass through, a forward groove for receiving the first magnet member, and a rearward groove for coupling the sleeve. The through-hole is disposed between the forward groove and the rearward groove.

### RELATED APPLICATION INFORMATION

This application claims the benefit under 35 U.S.C. §119(a) of Chinese Patent Application No. CN 201510117526.2, filed on Mar. 17, 2015, the disclosure of which is incorporated herein by reference in its entirety.

### FIELD OF THE DISCLOSURE

The present disclosure relates generally to accessories and, more particularly, to a bit holder and a combination of a tool bit and a bit holder.

### BACKGROUND OF THE DISCLOSURE

A bit holder is used to drive a bit to rotate a screw at a distance from an electronic screwdriver.

During operation of power tools such as electronic screwdrivers, it is generally needed to fix a bit holder to use a bit. However, the traditional bit holders have disadvantages. When using the power tool with the traditional bit holder to drive a screw, an operator often needs to hold the screw by one hand and grasp the power tool by another hand. Both hands of the operator are thus occupied and the work is laborsome. Further, the operator cannot do other things during operation of the tool in this manner.

The statements in this section merely provide background information related to the present disclosure and may not constitute prior art.

### SUMMARY

In one aspect of the disclosure, a bit holder includes a body having a shank at its rearward end and a socket formed at its forward end to allow a tool bit to be inserted therein, a sleeve slidably disposed on the body, a collar detachably coupled to the sleeve, and a first magnet member disposed at a forward side of the collar to magnetize a fastener to retain the fastener engaged to the tool bit. The collar defines a through-hole to allow the tool bit to pass through, a forward groove for receiving the first magnet member, and a rearward groove for coupling the sleeve. The through-hole is disposed between the forward groove and the rearward groove.

In another aspect of the disclosure, a bit holder includes a body having a shank at its rearward end and a socket formed at its forward end to allow a tool bit to be inserted therein, a collar detachably coupled to the forward end of the body, and a first magnet member disposed at a forward side of the collar to magnetize a fastener to retain the fastener engaged to the tool bit. The collar defines a through-hole to allow the tool bit to pass through, a forward groove for receiving the first magnet member, and a rearward groove for coupling the sleeve. The through-hole is disposed between the forward groove and the rearward groove.

In yet another aspect of the disclosure, a combination includes a bit and a bit holder. The bit holder includes a body having a shank at its rearward end and a socket formed at its forward end to allow a tool bit to be inserted therein, a sleeve slidably disposed on the body, a collar detachably coupled to the sleeve, and a first magnet member disposed at a forward side of the collar to magnetize a fastener to retain the fastener engaged to the tool bit. The collar defines a through-hole to allow the tool bit to pass through, a forward groove for receiving the first magnet member, and a rearward groove for coupling the sleeve. The through-hole is disposed between the forward groove and the rearward groove.

In yet another aspect of the disclosure, a combination includes a bit and a bit holder. The bit holder includes a body having a shank at its rearward end and a socket formed at its forward end to allow a tool bit to be inserted therein, a collar detachably coupled to the forward end of the body, and a first magnet member disposed at a forward side of the collar to magnetize a fastener to retain the fastener engaged to the tool bit. The collar defines a through-hole to allow the tool bit to pass through, a forward groove for receiving the first magnet member, and a rearward groove for coupling the sleeve. The through-hole is disposed between the forward groove and the rearward groove.

Further areas of applicability will become apparent from the description provided herein. It should be understood that the description and specific examples are intended for purposes of illustration only and are not intended to limit the scope of the invention hereinafter claimed.

### BRIEF DESCRIPTION OF THE DRAWINGS

FIG. 1 is a schematic view of an exemplary bit holder, the bit holder having a body, a sleeve, a collar, and a first magnet member.

FIG. 2 is a sectional view of the bit holder in FIG. 1.

FIG. 3 is a schematic view of the bit holder in FIG. 1 when the collar and the first magnet is uncoupled with the rest of the bit holder.

FIG. 4 is an exploded view of the collar and the first magnet in FIG. 3.

FIG. 5 is a schematic view of the bit holder in FIG. 1 when it is in use with a tool bit and a screw.

FIG. 6 is a schematic view of the bit holder in FIG. 1 when the sleeve slides forwardly.

FIG. 7 is a schematic view of the bit holder in FIG. 1 when it is in use with another tool bit which is longer than the tool bit in FIG. 5.

FIG. 8 is a schematic view of a combination of the bit holder in FIG. 1 and an annular member which is disposed on the body.

FIG. 9 is a schematic view of the combination in FIG. 8 in a condition that the collar is disposed on the annular member.

FIG. 10 is a schematic view of another bit holder.

The drawings described herein are for illustrative purposes only of selected embodiments and not all possible implementations, and are not intended to limit the scope of the invention hereinafter claimed.

Corresponding reference numerals indicate corresponding parts throughout the several views of the drawings.

### DETAILED DESCRIPTION

The following description of the preferred embodiments is merely exemplary in nature and is in no way intended to limit the invention claimed, its application, or uses.

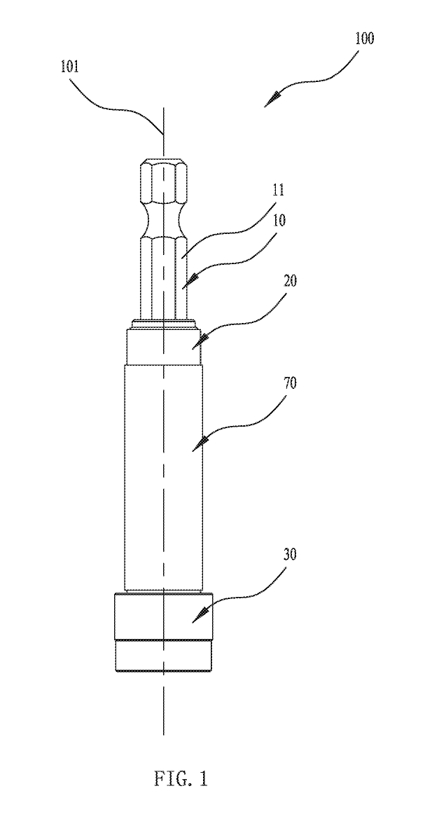

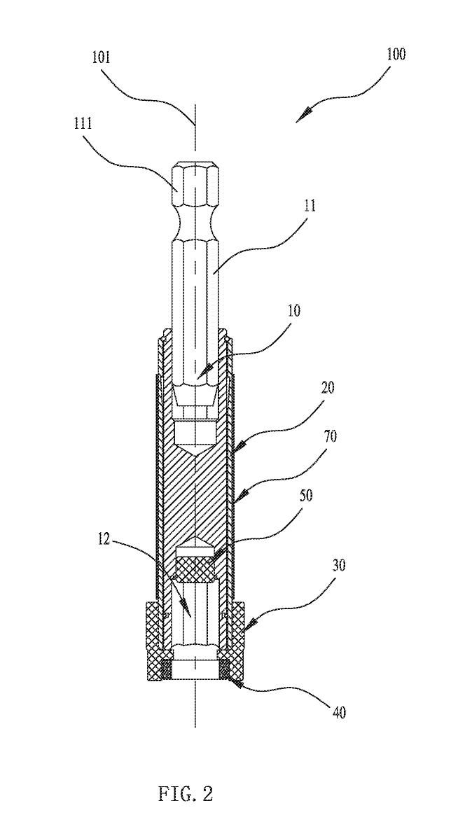

Referring to FIGS. 1-2, a bit holder 100 includes a body 10, a sleeve 20, a collar 30, and a first magnet member 40.

The body 10 has a shank 11 at its rearward end and a socket 12 formed at its forward end.

The shank 11 and the socket 12 can be formed by one piece or by two separate parts.

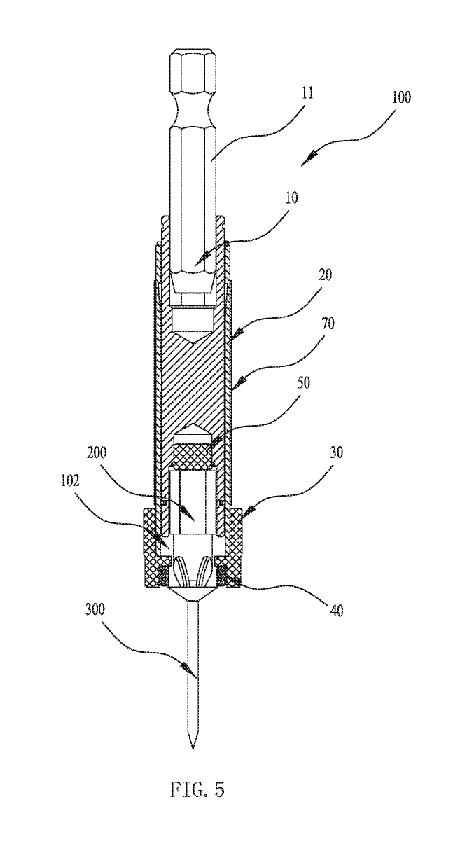

As shown in FIG. 1 and FIG. 5, the socket 12 is used to receive a tool bit 200. The tool bit 200 can be inserted into the socket 12.

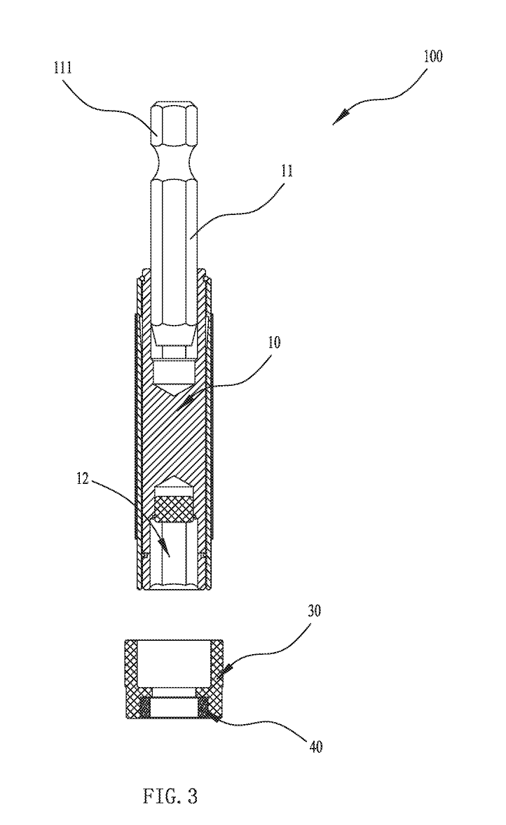

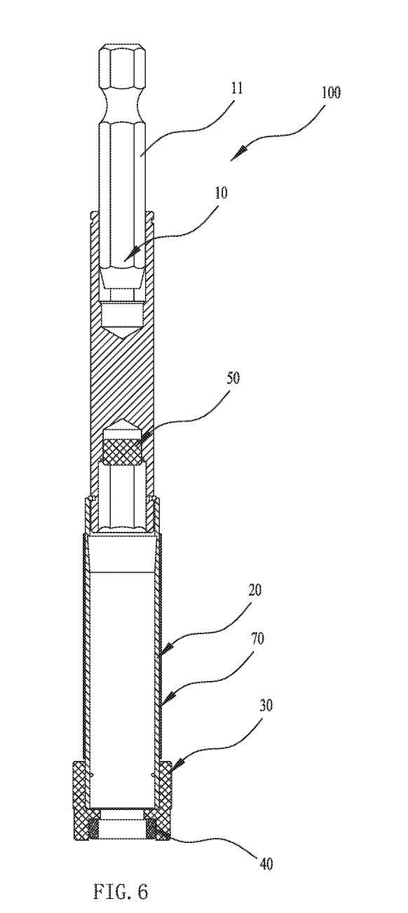

Referring also to FIGS. 3-7, the bit holder 100 further includes a second magnet member 50 which is disposed in the socket 12. The second magnet member 50 is used to magnetize a tool bit so as to keep the rear end of tool bit in the socket 12.

The shank 11 includes a driven portion 111 which is configured to connect to a power tool. The driven portion 111 has a hexagonal body for being driven by a torque which the power tool outputs.

The socket 12 defines a hexagonal hole for receiving a tool bit and transferring the torque from the power tool to the tool bit.

The sleeve 20 is slidably disposed on the body 10. The sleeve 20 has a tube structure for accommodating the body 10, and the sleeve 20 is capable of sliding relative to the body 10 along a direction which is substantially parallel to a rotating axis 101 of the body 10.

The bit holder 100 further includes a protect tube 70 which is disposed on an outer surface of the sleeve 20 and is used to protect the sleeve 20. The protect tube 70 may be made of an elastic material.

The collar 30 is detachably coupled to the sleeve 20. The collar 30 is used as a detachable accessory and may be a ring structure for being passed through by a screw or a nail.

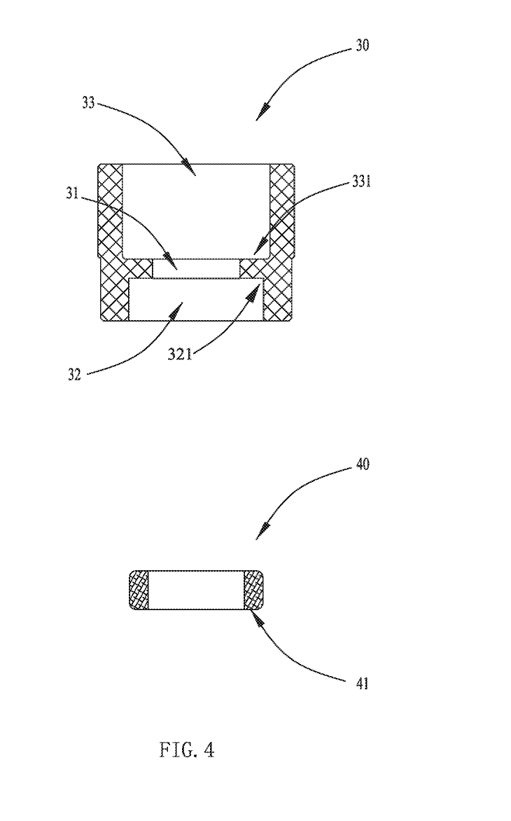

As shown in FIGS. 3-4, the collar 30 forms a through-hole 31, a forward groove 32 and a rearward groove 33.

The through-hole 31 is positioned between the forward groove 32 and the rearward groove 33. The through-hole 31 is configured to allow a tool bit to pass through.

The forward groove 32 is used to receive the first magnet member 40. The forward groove 32 has a forward step structure 321 for limiting the position of the first magnet member 40.

The rearward groove 33 is used to couple to the sleeve 20 so as to cause the collar 30 to be mounted at one end of the sleeve 20. The rearward groove 33 has a rearward step structure 331 to engage with the end surface and the outer surface of the sleeve 20.

The collar 30 may be made of an elastic material. Users can mount the collar 30 to the sleeve 20 conveniently by taking advantage of the elastic material.

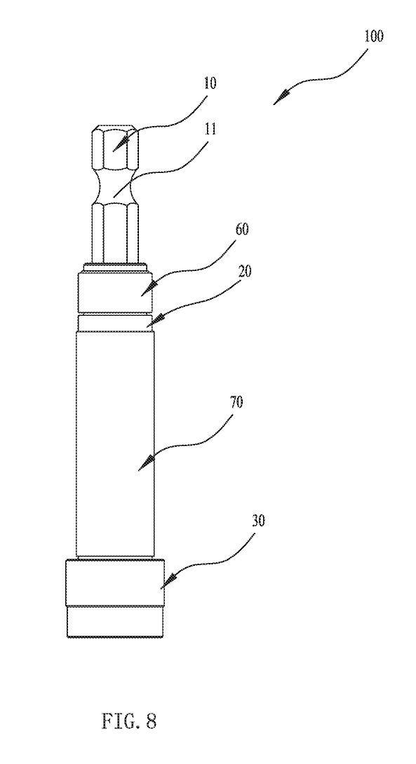

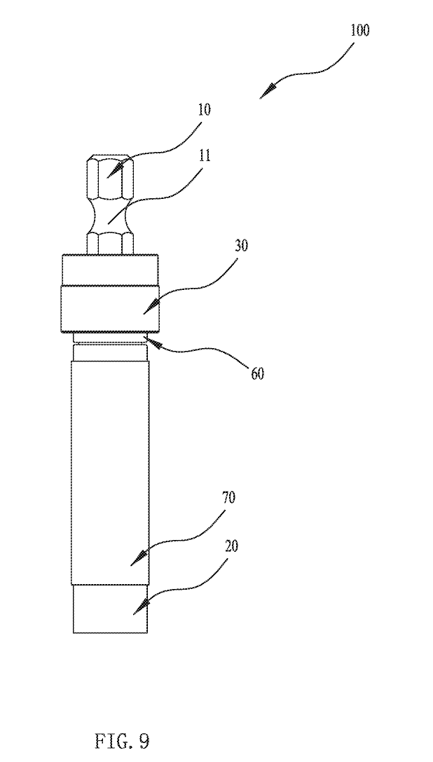

As shown in FIGS. 8-9, the bit holder 100 further includes a ring member 60 which is capable of coupling to the body 10. The ring member 60 has a hole for allowing the shank 11 to pass through, and the body 10 forms a step structure to preventing the ring member 60 from moving forward. The ring member 60 is used to couple the collar 30 to the body 10 when users do not use the function of the first magnet member 40.

The size of the sleeve 20 in the radial direction of the rotating axis 101 is greater than the size of the body 20 in the radial direction of the rotating axis 101. The ring member compensates the differences of the radial sizes between the sleeve 20 and the body 10 so as to allow users to mount the collar 30 to both of the body 10 and the sleeve 20 by the same rearward groove 33.

The first magnet member 40 is disposed at the forward side of the collar 30 to magnetize a fastener, such as a screw, and to retain the fastener engaged to a tool bit which is couple to the body 10. The first magnet member 40 has a ring structure and forms a contacting surface 41 which is formed in an annular shape.

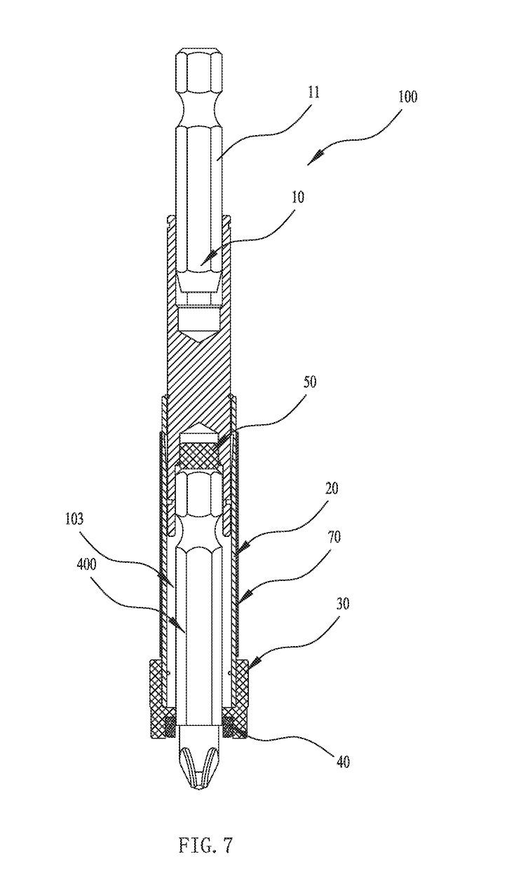

When users use a tool bit 200 to drive a screw 300, the sleeve 20 is located at a first position, the sleeve 200 and the socket 12 cooperatively define a first space 102 which is suitable to the length of the tool bit 200 as shown in FIG. 5. When users use a tool bit 400 which is longer than the tool bit 200, the sleeve 20 is located at a second position, the sleeve 200 and the socket 12 cooperatively define a second space 103 which is suitable to the tool bit 400 as shown in FIG. 7.

The collar 30 and the first magnet member 40 move with the sleeve 20 so as to be useful in connection with tool bits which have different lengths.

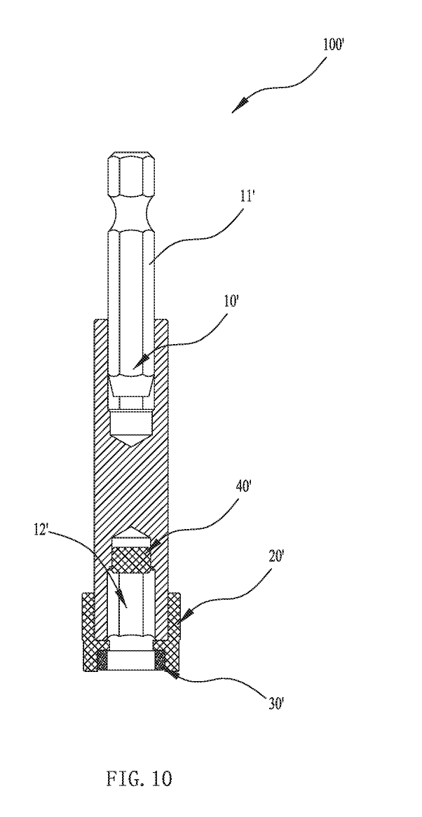

As shown as FIG. 10, in an alternative embodiment, a bit holder 100′ includes a body 10′, a collar 20′, and a first magnet member 30′.

The body 10′ has a shank 11′ at its rearward end and a socket 12′ formed at its forward end.

The shank 11′ and the socket 12′ may be formed by one piece or by two separate parts. The body 10′ has substantially the same structure as the body 10 in FIGS. 1-9.

The collar 20′ is detachably coupled to the body 10′. The collar 20′ is used as a detachable accessory and is configured to be a ring structure for being passed through by a screw or a nail.

The collar 20′ has substantially the same structure as the collar 30 in FIGS. 1-9 except for how it is mounted to the body 10′.

The first magnet member 30′ is disposed at a forward side of the collar 20′ to magnetize a fastener and retain the fastener engaged to a tool bit.

The bit holder 100′ further includes a second magnet member 40′ which is disposed in the socket 12 to magnetize a tool bit.

The differences between bit holder 100′ and bit holder 100 lies in that the bit holder 100 has a slidable sleeve 20 for coupling with the collar 30 and the bit holder 100′ has a collar 20′ for coupling to the body 10′ directly.

The above illustrates and describes basic principles, main features and advantages of the present invention. Those skilled in the art should appreciate that the above embodiments do not limit the present invention in any form. Technical solutions obtained by equivalent substitution or equivalent variations all fall within the scope of the claims hereinafter presented.

What is claimed is:

1. A bit holder comprising:
a body having a shank at its rearward end and a socket formed at its forward end to allow a tool bit to be inserted therein;
a sleeve slidably disposed on the body;
a collar detachably coupled to the sleeve, the collar defining a through-hole to allow the tool bit to pass through, a forward groove, and a rearward groove for coupling with the sleeve, wherein the through-hole is disposed between the forward groove and the rearward groove; and
a magnet member received in the forward groove for magnetizing a fastener and retaining the fastener engaged to the tool bit.

2. The bit holder of claim 1, wherein the magnet member has at least a contacting surface which is formed in an annular shape.

3. The bit holder of claim 1, wherein the collar is made of an elastic material.

4. The bit holder of claim 1, wherein the first magnet member is constructed to have a ring structure.

5. The bit holder of claim 1, further comprising a second magnet member disposed in the socket to magnetize the tool bit.

6. A bit holder comprising:
a body having a shank at its rearward end and a socket formed at its forward end to allow a tool bit to be inserted therein;
a collar detachably coupled to the forward end of the body; and
a magnet member disposed at a forward side of the collar to magnetize a fastener and retain the fastener engaged to the tool bit;
wherein the collar defines:
a through-hole to allow the tool bit to pass through;
a forward groove for receiving the first magnet member; and
a rearward groove for coupling the sleeve;
and wherein the through-hole is disposed between the forward groove and the rearward groove.

7. The bit holder of claim 6, wherein the magnet member has at least a contacting surface which is formed in an annular shape.

8. The bit holder of claim 6, wherein the collar is made of an elastic material.

9. The bit holder of claim 6, wherein the first magnet member is constructed to have a ring structure.

10. The bit holder of claim 6, further comprising a second magnet member disposed in the socket to magnetize the tool bit.

11. A combination of a bit holder and at least two tool bits, comprising:
a first tool bit;
a second tool bit having different length from the first tool bit; and
a bit holder comprising:
a body having a shank at its rearward end and a socket formed at its forward end;
a sleeve slidably disposed on the body, wherein when the sleeve is slide to a first position, the sleeve and the socket cooperatively define a first space for receiving the first tool bit, when the sleeve is slide to a second position different from the first position, the sleeve and the socket cooperatively define a second space for receiving the second tool bit;
a collar detachably coupled to the sleeve, the collar defining a through-hole to allow the first tool bit or the second tool bit to pass through, a forward groove, and a rearward groove for coupling with the sleeve, wherein the through-hole is disposed between the forward groove and the rearward groove; and
a magnet member positioned in the forward groove for magnetizing a fastener and retaining the fastener engaged to the first tool bit or the second tool bit.

12. The combination of claim 11, wherein the magnet member has at least a contacting surface which is formed in an annular shape.

13. The combination of claim 11, wherein the collar is made of an elastic material.

14. The combination of claim 11, wherein the magnet member is constructed to have a ring structure.

15. The combination of claim 11, further comprising a second magnet member disposed in the socket to magnetize the tool bit.

16. A combination of a bit holder and a tool bit, wherein the bit holder comprises:
a body having a shank at its rearward end and a socket formed at its forward end to allow the tool bit to be inserted therein;
a collar detachably coupled to the forward end of the body; and
a first magnet member disposed at a forward side of the collar to magnetize a fastener and retain the fastener engaged to the tool bit;
wherein the collar comprises:
a through-hole to allow the tool bit to pass through;
a forward groove for receiving the first magnet member; and
a rearward groove for coupling the sleeve;
and wherein the through-hole is disposed between the forward groove and the rearward groove.

17. The combination of claim 16, wherein the first magnet member has at least a contacting surface which is formed in an annular shape.

18. The combination of claim 16, wherein the collar consists of an elastic material.

19. The combination of claim 16, wherein the first magnet member is constructed to have a ring structure.

20. The combination of claim 16, further comprising a second magnet member disposed in the socket to magnetize the tool bit.
